(19) United States
(12) Patent Application Publication
(10) Pub. No.: US 2026/0101115 A1
(43) Pub. Date: Apr. 9, 2026

(54) APPARATUS AND METHOD FOR CONTROLLING LIGHT SOURCES FOR EYE TRACKING

(71) Applicant: Samsung Electronics Co., Ltd., Suwon-si (KR)

(72) Inventors: Bonkon KOO, Suwon-si (KR); Jinmo KANG, Suwon-si (KR); Kwangtai KIM, Suwon-si (KR); Sungoh KIM, Suwon-si (KR); Jisu RYU, Suwon-si (KR); Sungkweon PARK, Suwon-si (KR); Soonsang PARK, Suwon-si (KR); Donghyun YEOM, Suwon-si (KR); Kihuk LEE, Suwon-si (KR)

(21) Appl. No.: 19/416,579

(22) Filed: Dec. 11, 2025

Related U.S. Application Data
(63) Continuation of application No. PCT/KR2024/006573, filed on May 14, 2024.

(30) Foreign Application Priority Data
Jul. 21, 2023 (KR) 10-2023-0095411
Aug. 16, 2023 (KR) 10-2023-0107120

(51) Int. Cl. H04N 23/74; H04N 23/71; H05B 47/175

(52) U.S. Cl. CPC H04N 23/74; H04N 23/71; H05B 47/196

(57) ABSTRACT

An apparatus and a method for controlling light sources for eye tracking are provided. The method includes performing user calibration using eye tracking technology, by analyzing eye data of a user, which is acquired through the user calibration, and calculating an activity of each of light sources according to a gaze of the user, generating an activation map for each of the light sources, verifying a first gaze direction that is a gaze direction of the user identified from an image taken of the pupil of the user, verifying control information of each of the light sources corresponding to the first eye gaze in the activation map of each of the light sources, and controlling each of the light sources according to the control information.

### CROSS-REFERENCE TO RELATED APPLICATION(S)

This application is a continuation application, claiming priority under 35 U.S.C. § 365(c), of an International application No. PCT/KR2024/006573, filed on May 14, 2024, which is based on and claims the benefit of a Korean patent application number 10-2023-0095411, filed on Jul. 21, 2023, in the Korean Intellectual Property Office, and of a Korean patent application number 10-2023-0107120, filed on Aug. 16, 2023, in the Korean Intellectual Property Office, the disclosure of each of which is incorporated by reference herein in its entirety.

### BACKGROUND

### 1. Field

The disclosure relates to technology for eye tracking in an extended reality (XR) device.

### 2. Description of Related Art

Most extended reality (XR) devices use a camera (e.g., an infrared ray (IR) camera) and a light source (e.g., an IR light-emitting diode (LED)) to acquire eye information. This is because the configuration of an eye tracking sensor may acquire eye information of a user as it is, as if a person is looking at something, thereby making analysis easy, and because an IR camera has been widely used for a long time, there are many eye tracking studies using the IR camera. Eye tracking technology using an IR camera and an IR LED is operated by analyzing a relationship in which the light emitted by the IR LED bounces into the user's eyes and is input to the IR camera. However, since the locations of the IR LED, which may form a glint, vary depending on the locations of the user's eyes, the operation stability of the eye tracking technology is usually secured by placing several IR LEDs around the user's eyes.

Most XR devices of the related art including eye tracking provide eye tracking technology by turning on all IR LEDs or dividing the IR LEDs into small groups of 2 or 3 and flashing the IR LEDs in a circular manner. The background of this control is to secure a glint formation area as wide as possible in a situation in which there is no clue where the user's eyes are. However, this control method is inefficient in terms of power consumption because the method even uses unnecessary IR LEDs that do not form a glint. In addition, this control method increases the difficulty of developing a glint detector because the light of unnecessary IR LEDs, which do not form a glint, is applied as interference in terms of eye tracking accuracy.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for controlling a light source for open eye tracking.

Additional aspects will be set forth in part in the description which follows and, in part, will be apparent from the description, or may be learned by practice of the presented embodiments.

In accordance with an aspect of the disclosure, a method of controlling a light source for eye tracking is provided. The method includes performing user calibration using eye tracking technology, by analyzing eye data of a user, which is acquired through the user calibration, and calculating an activity of each of light sources according to a gaze of the user, generating an activation map of each of the light sources, verifying a first eye gaze that is an eye gaze of the user, which is verified through an image obtained by capturing a pupil of the user, verifying control information of each of the light sources corresponding to the first eye gaze in the activation map of each of the light sources, and controlling each of the light sources according to the control information.

In accordance with another aspect of the disclosure, an apparatus for controlling a light source for eye tracking is provided. The apparatus includes a camera configured to capture eyes of a user, light sources configured to acquire eye information of the user, a calibration processing portion configured to perform user calibration using eye tracking technology, an activation map generation portion configured to generate, by analyzing eye data of the user, which is acquired through the user calibration, and calculating an activity of each of the light sources according to a gaze of the user, an activation map of each the light sources, a first eye tracking portion configured to verify a first eye gaze, which is an eye gaze of the user, through an eye image of the user, which is captured by the camera, a control information verification portion configured to verify control information of each of the light sources corresponding to the first eye gaze in the activation map of each of the light sources, and a light control portion configured to control each of the light sources according to the control information.

In accordance with another aspect of the disclosure, one or more non-transitory computer-readable storage media storing one or more computer programs including computer-executable instruction that, when executed by one or more processors of an apparatus individually or collectively, cause the apparatus to perform operations of controlling a light source for eye tracking are provided. The operations include performing user calibration using eye tracking technology, by analyzing eye data of a user, which is acquired through the user calibration, and calculating an activity of each of light sources according to a gaze of the user, generating an activation map of each of the light sources, verifying a first eye gaze that is an eye gaze of the user, which is verified through an image obtained by capturing a pupil of the user, verifying control information of each of the light sources corresponding to the first eye gaze in the activation map of each of the light sources, and controlling each of the light sources according to the control information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flowchart illustrating a process of controlling a light source for eye tracking according to an embodiment of the disclosure;

FIGS. 2A and 2B are diagrams illustrating a light source that forms a glint according to an eye gaze of a user according to an embodiment of the disclosure;

FIG. 3 is a diagram illustrating controlling a light source for eye tracking according to an embodiment of the disclosure;

FIG. 4 is a diagram illustrating a schematic configuration of an apparatus for controlling a light source for eye tracking according to an embodiment of the disclosure;

FIG. 5 is a block diagram illustrating an electronic device in a network environment according to an embodiment of the disclosure; and

FIG. 6 is a diagram illustrating a structure of an electronic device implemented in a form of wearable augmented reality (AR) glasses according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components regardless of drawing numbers and a repeated description related thereto will be omitted. In the description of embodiments of the disclosure, detailed description of well-known related technology will be omitted when it is deemed that such description will cause ambiguous interpretation of the disclosure.

In addition, in the description of the components of the embodiments of the disclosure, terms, such as first, second, A, B, (a), (b), and the like may be used. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to the other component, and an intervening component may also be “connected”, “coupled”, or “attached” to the components.

The same name may be used to describe an element included in the embodiments described above and an element having a common function. Unless otherwise mentioned, the descriptions of the embodiments may be applicable to the following embodiments and thus, duplicated descriptions will be omitted for conciseness.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

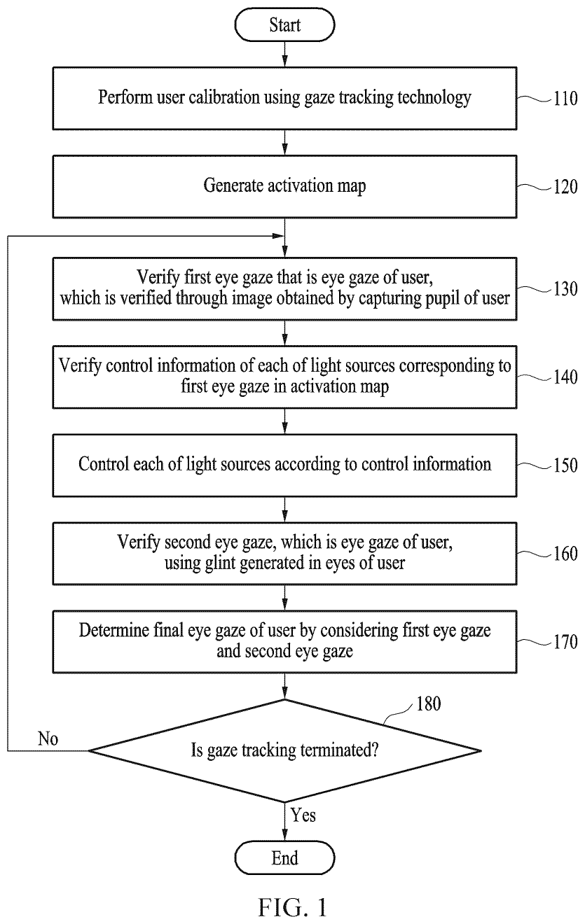

Hereinafter, a method and an apparatus for controlling a light source for eye tracking, according to an embodiment of the disclosure, are described with reference to FIGS. 1 to 6.

FIG. 1 is a flowchart illustrating a process of controlling a light source for eye tracking, according to an embodiment of the disclosure.

Referring to FIG. 1, in operation 110, an apparatus (hereinafter, referred to as an electronic device) for controlling a light source for eye tracking of the disclosure may perform user calibration using eye tracking technology.

Here, the user calibration may be a process performed before using the user eye tracking technology of an extended reality (XR) device. During the user calibration process, the electronic device may use a display of a device to show a user objects (e.g., a dot, a star shape, and the like) on which the user may focus in one area of the display, and here, the user may be asked to look at an object on which the user may focus. Specifically, during the user calibration process, the electronic device may collect eye data of the user while the user looks at the object. Then, after a sufficient amount of eye data is collected, the electronic device may re-display the objects on which the user may focus in another area of the display, induce the user to look at a new location, and collect the eye data. By repeatedly performing the above process, the electronic device may collect the eye data of the user when the user looks at all parts of the display.

Then, in operation 120, the electronic device may generate an activation map of each of the light sources by analyzing the eye data of the user, which is acquired through the user calibration, and calculating the activity of each of the light sources according to the gaze of the user. Here, the activation map may include control information corresponding to operation state information of each of the light sources according to the eye gaze of the user.

Here, the activation map may be expressed in the form of a matrix.

For example, the activation map may be expressed as a three-dimensional (3D) matrix, in which a first axis of the 3D matrix may represent an X-axis gaze direction of the user, a second axis may represent a Y-axis gaze direction of the user, a third axis may represent identification information that identifies a light source, and a cell value of the 3D matrix may be control information of a light source corresponding to identification information under a corresponding condition.

Furthermore, the activation map may also be expressed as a probability distribution function.

For example, the activation map may be expressed as a 3D probability distribution, and an input of the probability may be the identification information that identifies the gaze direction (X-axis) of the user, the gaze direction (Y-axis) of the user, and the light source, and in this case, a probability value may be control information of a corresponding light source.

In addition, the activation map may also be expressed as a two-dimensional (2D) probability distribution function for each light source.

Then, in operation 130, the electronic device may verify a first eye gaze that is the eye gaze of the user, which is verified through an image obtained by capturing the pupil of the user.

Then, in operation 140, the electronic device may verify the control information of each of the light sources corresponding to the first eye gaze in the activation map. In operation 140, the electronic device may verify the control information of each of the light sources in the activation map by considering not only the first eye gaze but also a previous eye gaze of the user. For example, the electronic device may supplement the first eye gaze by performing a weighted average on the first eye gaze and the previous eye gaze of the user and may verify the control information of each of the light sources corresponding to the supplemented eye gaze in the activation map.

Furthermore, the control information of each of the light sources may be information to turn each of the light sources on or off. For example, the control information of each of the light sources may be information to turn each of the light sources on or off, each of which is indicated by 0 or 1.

On the other hand, the control information of each of the light sources may be information indicating the brightness of each of the light sources. For example, the control information of each of the light sources may be information indicating a brightness value of each of the light sources, each of which is indicated as a real value between 0 and 1.

In operation 140, the electronic device may set the control information to turn each of the light sources on at the preset brightness when the first eye gaze is not detected. Here, the preset brightness may be the brightness required to capture the pupil of the user using a camera to detect the gaze direction of the user.

Then, in operation 150, the electronic device may control each of the light sources according to the control information.

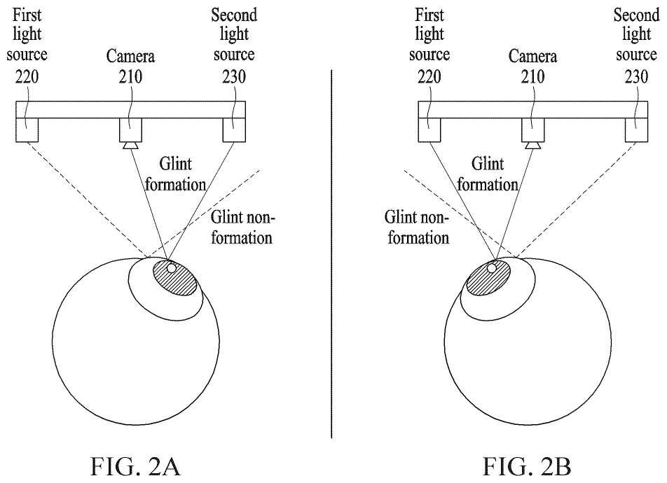

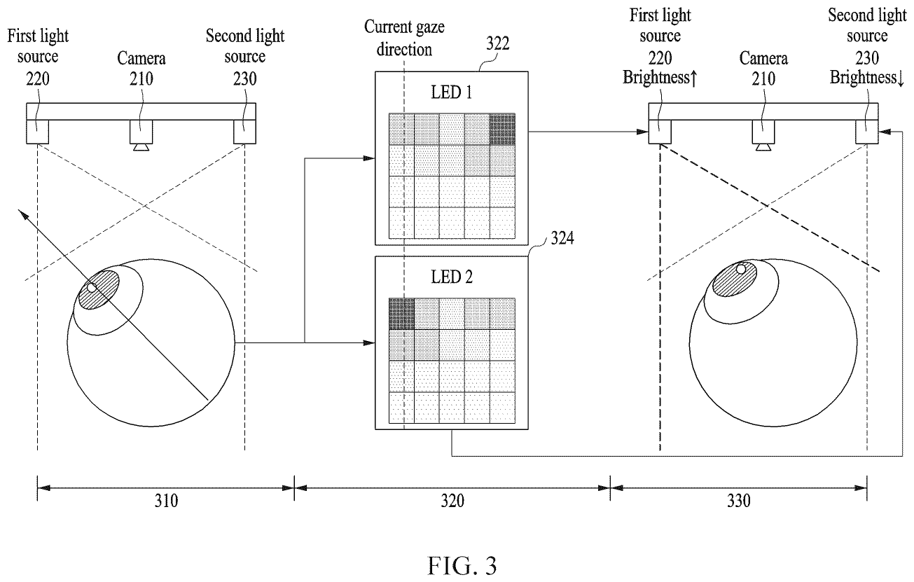

The reason for controlling the light sources according to the gaze of the user through operations 130 to 150 is described below with reference to FIGS. 2 and 3.

FIG. 2 is a diagram illustrating an example of a light source that forms a glint according to the eye gaze of a user, according to an embodiment of the disclosure.

Referring to FIG. 2A, when it is verified that the eyeballs of the user face to the right through a camera 210, it may be seen that a first light source 220 does not form a glint because the light does not reach the pupil but a second light source 230 forms a glint because the light reaches the pupil.

In FIG. 2B, when it is verified that the eyeballs of the user face to the left through the camera 210, it may be seen that the first light source 220 forms a glint because the light reaches the pupil but the second light source 230 does not form a glint because the light does not reach the pupil.

Since the first light source 220 of FIG. 2A and the second light source 230 of FIG. 2B do not form a glint, the first light source 220 and the second light source 230 may become unnecessary light and may actually act as interference with other light sources that form a glint. Accordingly, it may be desirable to turn off or minimize the first light source 220 of FIG. 2A and the second light source 230) of FIG. 2B.

FIG. 3 is a diagram illustrating an example of controlling a light source for eye tracking, according to an embodiment of the disclosure.

Referring to FIG. 3, in operation 310, an electronic device may verify an eye gaze of a user through the camera 210.

Then, in operation 320, the electronic device may verify control information of each of the first light source 220 and the second light source 230 using an activation map 322 corresponding to the first light source 220 and an activation map 324 corresponding to the second light source 230.

Then, in operation 330, according to the control information verified in operation 320, the electronic device may adjust the brightness of the first light source 220 to be high and the brightness of the second light source 230 to be low.

Then, in operation 160, the electronic device may verify a second eye gaze, which is an eye gaze of the user, using a glint generated in the eyes of the user by the light sources controlled according to the control information.

Then, in operation 170, the electronic device may determine the final eye gaze of the user by considering the first eye gaze and the second eye gaze.

Then, in operation 180, the electronic device may verify whether eye tracking is terminated.

As a result of the verification in operation 180, when eye tracking is not terminated, the electronic device may return to operation 130 and repeat the subsequent operations.

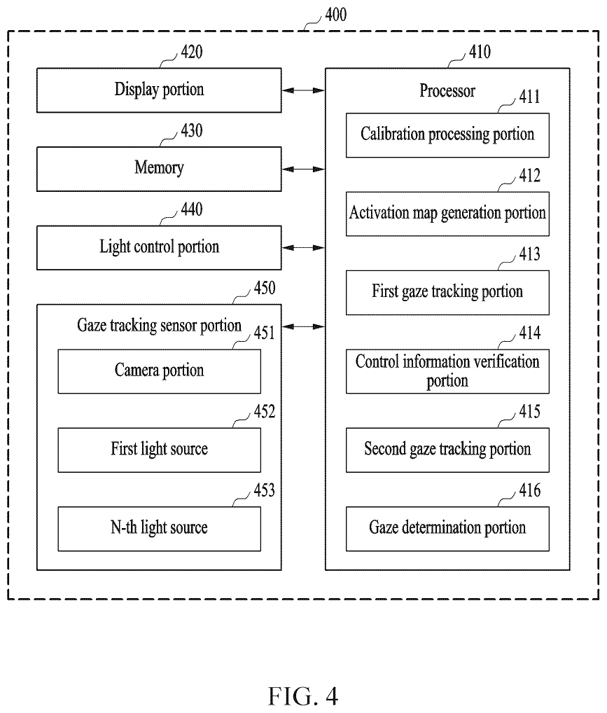

FIG. 4 is a diagram illustrating a schematic configuration of an apparatus for controlling a light source for eye tracking, according to an embodiment of the disclosure.

Referring to FIG. 4, an apparatus (hereinafter, referred to as an electronic device 400) for controlling a light source for eye tracking may include a processor 410, a display portion 420, memory 430, a light control portion 440, and an eye tracking sensor portion 450.

The processor 410 may include a calibration processing portion 411, an activation map generation portion 412, a first eye tracking portion 413, a control information verification portion 414, a second eye tracking portion 415, and a gaze determination portion 416.

The calibration processing portion 411 may perform user calibration using eye tracking technology.

More specifically, the calibration processing portion 411 may use the display portion 420 of a device to show a user objects (e.g., a dot, a star shape, and the like) on which the user may focus in one area of a display, and here, the user may be asked to look at an object on which the user may focus. In addition, the calibration processing portion 411 may collect eye data of the user while the user looks at the object. In addition, after a sufficient amount of eye data is collected, the calibration processing portion 411 may re-display the objects on which the user may focus in another area of the display, induce the user to look at a new location, and collect the eye data. The calibration processing portion 411 may repeatedly perform the above process and collect the eye data of the user when the user looks at all parts of the display.

The activation map generation portion 412 may generate an activation map of each of the light sources by analyzing the eye data of the user, which is acquired through the user calibration, and calculating the activity of each of the light sources according to the gaze of the user. Here, the activation map may include control information corresponding to operation state information of each of the light sources according to the eye gaze of the user.

Here, the activation map may be expressed in the form of a matrix.

For example, the activation map may be expressed as a 3D matrix, in which a first axis of the 3D matrix may represent an X-axis gaze direction of the user, a second axis may represent a Y-axis gaze direction of the user, a third axis may represent identification information that identifies a light source, and a cell value of the 3D matrix may be control information of a light source corresponding to identification information under a corresponding condition.

Furthermore, the activation map may also be expressed as a probability distribution function.

For example, the activation map may be expressed as a 3D probability distribution, and an input of the probability may be the identification information that identifies the gaze direction (X-axis) of the user, the gaze direction (Y-axis) of the user, and the light source, and in this case, a probability value may be control information of a corresponding light source.

In addition, the activation map may also be expressed as a 2D probability distribution function for each light source.

The first eye tracking portion 413 may verify a first eye gaze, which is an eye gaze of the user, by analyzing an eye image of the user captured by a camera portion 451.

The control information verification portion 414 may verify the control information of each of the light sources corresponding to the first eye gaze in the activation map of each of the light sources.

The control information verification portion 414 may verify the control information of each of the light sources in the activation map by considering not only the first eye gaze but also a previous eye gaze of the user. For example, the electronic device may supplement the first eye gaze by performing a weighted average on the first eye gaze and the previous eye gaze of the user and may verify the control information of each of the light sources corresponding to the supplemented eye gaze in the activation map.

Here, the control information of each of the light sources may be information to turn each of the light sources on or off. For example, the control information of each of the light sources may be information to turn each of the light sources on or off, each of which is indicated by 0 or 1.

On the other hand, the control information of each of the light sources may be information indicating the brightness of each of the light sources. For example, the control information of each of the light sources may be information indicating a brightness value of each of the light sources, each of which is indicated as a real value between 0 and 1.

The control information verification portion 414 may set the control information to turn each of the light sources on at the preset brightness when the first eye gaze is not detected. Here, the preset brightness may be the minimum brightness required to capture the pupil of the user using the camera portion 451 to detect the gaze direction of the user.

The second eye tracking portion 415 may verify a second eye gaze, which is an eye gaze of the user, using a glint generated in the eyes of the user by the light sources controlled according to the control information.

The gaze determination portion 416 may determine the final eye gaze of the user by considering the first eye gaze and the second eye gaze. For example, the gaze determination portion 416 may determine the final eye gaze by performing a weighted average on the first eye gaze and the second eye gaze.

The display portion 420 may display state information (or an indicator), limited numbers and characters, moving pictures, and still pictures, which are generated during an operation of the electronic device 400. In addition, according to the disclosure, objects (e.g., a point, a star shape, and the like) on which the user may focus may be displayed under the control of the calibration processing portion 411 for user calibration.

The memory 430 may store an operating system, an application program, and storage data for controlling the overall operation of the electronic device 400. Additionally, the memory 430 may store an activation map corresponding to each of a plurality of light sources 452 and 453 generated by the activation map generation portion 412 according to the disclosure.

The light control portion 440 may control the on/off or brightness of each of the plurality of light sources 452 and 453 according to the control information that is verified by the control information verification portion 414. Although the light control portion 440 is implemented as a separate device in FIG. 4, the light control portion 440 may be included in the processor 410 and operate.

The eye tracking sensor portion 450 may include the camera portion 451 and the plurality of light sources 452 and 453.

The camera portion 451 may capture the eyes of the user to acquire and track the eye gaze of the user. Here, the camera portion 451 may be an infrared camera.

The plurality of light sources 452 and 453 may turn light on/off under the control of the light control portion 440 to acquire eye information of the user and may adjust the brightness of the light. Here, the plurality of light sources 452 and 453 may be infrared light sources and may include an infrared ray (IR) light-emitting diode (LED).

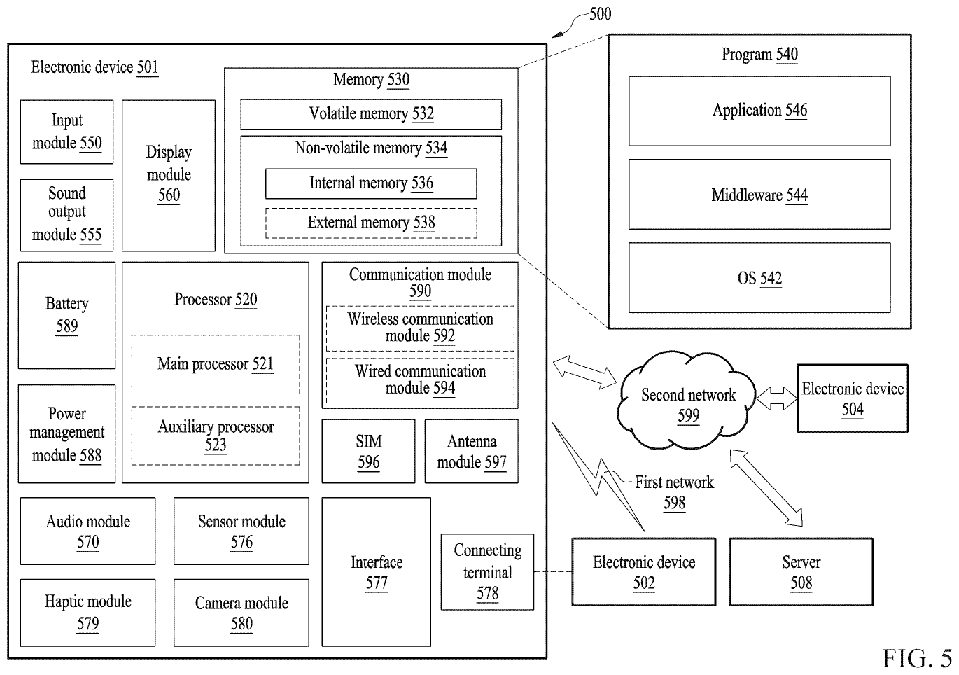

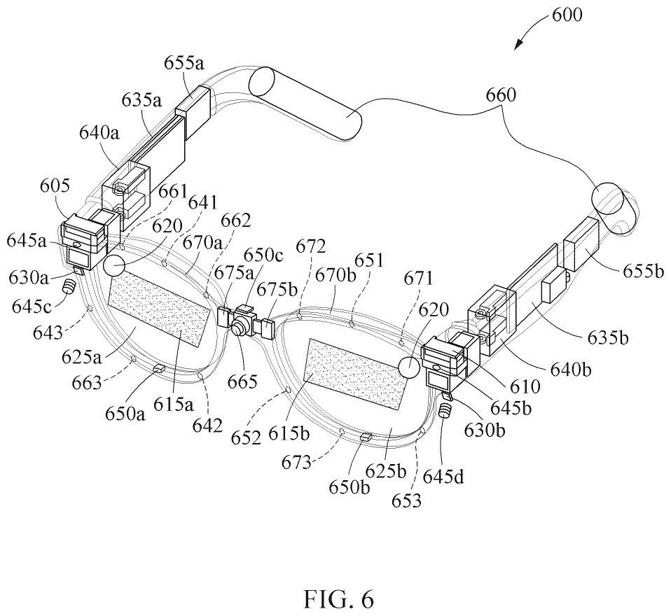

Furthermore, the electronic device 400 of FIG. 4 may be configured in the form of an electronic device 301 in a network environment as shown in FIG. 5 below or may be configured in the form of wearable augmented reality (AR) glasses (e.g., an electronic device 600 as shown in FIG. 6).

FIG. 5 is a block diagram illustrating an electronic device in a network environment 500, according to an embodiment of the disclosure.

Referring to FIG. 5, an electronic device 501 in a network environment 500 may communicate with an external electronic device 502 via a first network 598 (e.g., a short-range wireless communication network), or communicate with at least one of an external electronic device 504 or a server 508 via a second network 599 (e.g., a long-range wireless communication network). According to an embodiment of the disclosure, the electronic device 501 may communicate with the external electronic device 504 via the server 508. According to an embodiment of the disclosure, the electronic device 501 may include a processor 520, memory 530, an input module 550, a sound output module 555, a display module 560, an audio module 570, and a sensor module 576, an interface 577, a connecting terminal 578, a haptic module 579, a power management module 588, a battery 589, a communication module 590, a subscriber identification module (SIM) 596, or an antenna module 597. In some embodiments of the disclosure, at least one of the components (e.g., the connecting terminal 578) may be omitted from the electronic device 501, or one or more other components may be added to the electronic device 501. In some embodiments of the disclosure, some of the components (e.g., the sensor module 576, the camera module 580, or the antenna module 597) may be integrated as a single component (e.g., the display module 560).

The processor 520 may execute, for example, software (e.g., a program 540) to control at least one other component (e.g., a hardware or software component) of the electronic device 501 connected to the processor 520 and may perform various data processing or computations. According to an embodiment of the disclosure, as at least part of data processing or computation, the processor 520 may store a command or data received from another component (e.g., the sensor module 576 or the communication module 590) in volatile memory 532, process the command or the data stored in the volatile memory 532, and store resulting data in non-volatile memory 534. The non-volatile memory 534 may include internal memory 536 and external memory 538. According to an embodiment of the disclosure, the processor 520 may include a main processor 521 (e.g., a central processing unit (CPU) or an application processor (AP)) or an auxiliary processor 523 (e.g., a graphics processing unit (GPU), a neural processing unit (NPU), an image signal processor (ISP), a sensor hub processor, or a communication processor (CP)) that is operable independently of, or in conjunction with the main processor 521. For example, when the electronic device 501 includes the main processor 521 and the auxiliary processor 523, the auxiliary processor 523 may be adapted to consume less power than the main processor 521 or to be specific to a specified function. The auxiliary processor 523 may be implemented separately from the main processor 521 or as a part of the main processor 521.

The auxiliary processor 523 may control at least some of functions or states related to at least one (e.g., the display module 560, the sensor module 576, or the communication module 590) of the components of the electronic device 501, instead of the main processor 521 while the main processor 521 is in an inactive (e.g., a sleep) state or along with the main processor 521 while the main processor 521 is an active state (e.g., executing an application). According to an embodiment of the disclosure, the auxiliary processor 523 (e.g., an ISP or a CP) may be implemented as a portion of another component (e.g., the camera module 580 or the communication module 590) that is functionally related to the auxiliary processor 523. According to an embodiment of the disclosure, the auxiliary processor 523 (e.g., an NPU) may include a hardware structure specified for artificial intelligence (AI) model processing. The AI model may be generated by machine learning. The machine learning may be performed by, for example, the electronic device 501, in which AI is performed, or performed via a separate server (e.g., the server 508). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

Furthermore, the processor 520 may perform the operation of the processor 410 of FIG. 4.

The memory 530 may store various pieces of data used by at least one component (e.g., the processor 520 or the sensor module 576) of the electronic device 501. The various pieces of data may include, for example, software (e.g., the program 540) and input data or output data for a command related thereto. The memory 530 may include the volatile memory 532 or the non-volatile memory 534.

The program 540 may be stored as software in the memory 530, and may include, for example, an operating system (OS) 542, middleware 544, or an application 546.

The input module 550 may receive, from outside (e.g., a user) the electronic device 501, a command or data to be used by another component (e.g., the processor 520) of the electronic device 501. The input module 550 may include, for example, a microphone, a mouse, a keyboard, a key (e.g., a button), or a digital pen (e.g., a stylus pen).

The sound output module 555 may output a sound signal to the outside of the electronic device 501. The sound output module 555 may include, for example, a speaker or a receiver. The speaker may be used for general purposes, such as playing multimedia or playing record. The receiver may be used to receive an incoming call. According to an embodiment of the disclosure, the receiver may be implemented separately from the speaker or as a part of the speaker.

The display module 560 may visually provide information to the outside (e.g., a user) of the electronic device 501. The display module 560 may include, for example, a display, a hologram device, or a projector and control circuitry to control a corresponding one of the display, the hologram device, and the projector. According to an embodiment of the disclosure, the display module 560 may include a touch sensor adapted to detect a touch, or a pressure sensor adapted to measure an intensity of a force incurred by the touch.

The audio module 570 may convert a sound into an electric signal and vice versa. According to an embodiment of the disclosure, the audio module 570 may obtain the sound via the input module 550 or output the sound via the sound output module 555 or an external electronic device (e.g., the external electronic device 502, such as a speaker or a headphone) directly or wirelessly coupled with the electronic device 501.

The sensor module 576 may detect an operational state (e.g., power or temperature) of the electronic device 501 or an environmental state (e.g., a state of a user) external to the electronic device 501 and generate an electrical signal or data value corresponding to the detected state. According to an embodiment of the disclosure, the sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, a Hall sensor, or an illuminance sensor.

Furthermore, the sensor module 576 may include the camera portion 451 and the plurality of light sources 452 and 453 of FIG. 4.

In addition, the sensor module 576 may further include a camera module that may a still image and moving images. The camera module may include one or more lenses, image sensors, ISPs, or flashes.

The interface 577 may support one or more specified protocols to be used for the electronic device 501 to be coupled with the external electronic device (e.g., the external electronic device 502) directly (e.g., by wire) or wirelessly. According to an embodiment of the disclosure, the interface 577 may include, for example, a high-definition multimedia interface (HDMI), a universal serial bus (USB) interface, a secure digital (SD) card interface, or an audio interface.

For example, the electronic device 501 may transmit an image signal to an external electronic device through the connecting terminal 578. The electronic device 501 may transmit an image signal that allows the external electronic device to output an image to the display module 560 of the external electronic device.

The connecting terminal 578 may be used to output an image signal or a voice signal. For example, the connecting terminal 578 may simultaneously output an image signal and a voice signal. For example, the electronic device 501 may output an image signal and a voice signal through an interface, such as an HDMI, a DisplayPort (DP), or a Thunderbolt, in the connecting terminal 578 that simultaneously outputs the image and the voice signal.

The connecting terminal 578 may include a connector via which the electronic device 501 may be physically connected to an external electronic device (e.g., the external electronic device 502). According to an embodiment of the disclosure, the connecting terminal 578 may include, for example, an HDMI connector, a USB connector, an SD card connector, or an audio connector (e.g., a headphone connector).

The haptic module 579 may convert an electric signal into a mechanical stimulus (e.g., a vibration or a movement) or an electrical stimulus which may be recognized by a user via his or her tactile sensation or kinesthetic sensation. According to an embodiment of the disclosure, the haptic module 579 may include, for example, a motor, a piezoelectric element, or an electric stimulator.

The power management module 588 may manage power supplied to the electronic device 501. According to an embodiment of the disclosure, the power management module 588 may be implemented as, for example, at least a part of a power management integrated circuit (PMIC).

The battery 589 may supply power to at least one component of the electronic device 501. According to an embodiment of the disclosure, the battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the external electronic device 502, the external electronic device 504, or the server 508) and performing communication via the established communication channel. The communication module 590 may include one or more CPs that are operable independently of the processor 520 (e.g., an AP) and that support a direct (e.g., wired) communication or a wireless communication. According to an embodiment of the disclosure, the communication module 590 may include a wireless communication module 592 (e.g., a cellular communication module, a short-range wireless communication module, or a global navigation satellite system (GNSS) communication module) or a wired communication module 594 (e.g., a local area network (LAN) communication module, or a power line communication (PLC) module). A corresponding one of these communication modules may communicate with the external electronic device 504 via the first network 598 (e.g., a short-range communication network, such as Bluetooth™, wireless-fidelity (Wi-Fi) direct, or infrared data association (IrDA)) or the second network 599 (e.g., a long-range communication network, such as a legacy cellular network, a fifth generation (5G) network, a next-generation communication network, the Internet, or a computer network (e.g., a LAN or a wide area network (WAN)). These various types of communication modules may be implemented as a single component (e.g., a single chip), or may be implemented as multi components (e.g., multi chips) separate from each other. The wireless communication module 592 may identify and authenticate the electronic device 501 in a communication network, such as the first network 598 or the second network 599, using subscriber information (e.g., international mobile subscriber identity (IMSI)) stored in the SIM 596.

The wireless communication module 592 may support a 5G network after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 592 may support a high-frequency band (e.g., a millimeter wave (mmWave) band) to achieve, e.g., a high data transmission rate. The wireless communication module 592 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 592 may support various requirements specified in the electronic device 501, an external electronic device (e.g., the external electronic device 504), or a network system (e.g., the second network 599). According to an embodiment of the disclosure, the wireless communication module 592 may support a peak data rate (e.g., 20 Gbps or more) for implementing eMBB, loss coverage (e.g., 164 dB or less) for implementing mMTC, or user plane (U-plane) latency (e.g., 0.5 millisecond (ms) or less for each of downlink (DL) and uplink (UL), or a round trip of 1 ms or less) for implementing URLLC.

The antenna module 597 may transmit or receive a signal or power to or from the outside (e.g., an external electronic device) of the electronic device 501. According to an embodiment of the disclosure, the antenna module 597 may include an antenna including a radiating element including a conductive material or a conductive pattern formed in or on a substrate (e.g., a printed circuit board (PCB)). According to an embodiment of the disclosure, the antenna module 597 may include a plurality of antennas (e.g., array antennas). In such a case, at least one antenna appropriate for a communication scheme used in a communication network, such as the first network 598 or the second network 599, may be selected by, for example, the communication module 590 from the plurality of antennas. The signal or power may be transmitted or received between the communication module 590 and the external electronic device via the at least one selected antenna. According to an embodiment of the disclosure, another component (e.g., a radio frequency integrated circuit (RFIC)) other than the radiating element may be additionally formed as a part of the antenna module 597.

According to embodiments of the disclosure, the antenna module 597 may form a mmWave antenna module. According to an embodiment of the disclosure, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 501 and the external electronic device 504 via the server 508 coupled with the second network 599. Each of the external electronic devices 502 and 504 may be a device of a same type as, or a different type from, the electronic device 501. According to an embodiment of the disclosure, all or some of operations to be executed by the electronic device 501 may be executed at one or more external electronic devices (e.g., the external electronic devices 502 and 504, or the server 508). For example, if the electronic device 501 needs to perform a function or a service automatically, or in response to a request from a user or another device, the electronic device 501, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 501. The electronic device 501 may provide the outcome, with or without further processing of the outcome, as at least part of a reply to the request. To that end, a cloud computing, distributed computing, mobile edge computing (MEC), or client-server computing technology may be used, for example. The electronic device 501 may provide ultra low-latency services using, e.g., distributed computing or MEC. In an embodiment of the disclosure, the external electronic device 504 may include an Internet-of-things (IoT) device. The server 508 may be an intelligent server using machine learning and/or a neural network. According to an embodiment of the disclosure, the external electronic device 504 or the server 508 may be included in the second network 599. The electronic device 501 may be applied to intelligent services (e.g., a smart home, a smart city, a smart car, or healthcare) based on 5G communication technology or IoT-related technology.

FIG. 6 is a diagram illustrating a structure of an electronic device implemented in the form of wearable augmented reality (AR) glasses, according to an embodiment of the disclosure.

Referring to FIG. 6, an electronic device 600 may be worn on the face of a user to provide an image associated with an AR service and/or a virtual reality (VR) service to the user.

In an embodiment of the disclosure, the electronic device 600 may include a first display 605, a second display 610, a first screen display portion 615a, a second screen display portion 615b, an input optical member 620, a first transparent member 625a, a second transparent member 625b, lighting portions 630a and 630b, a first PCB 635a, a second PCB 635b, a first hinge 640a, a second hinge 640b, first cameras 645a, 645b, 645c, and 645d, a plurality of microphones (e.g., a first microphone 650a, a second microphone 650b, and a third microphone 650c), a plurality of speakers (e.g., a first speaker 655a and a second speaker 655b), a battery 660, second cameras 675a and 675b, a third camera 665, visors 670a and 670b, right eye light sources 641, 642, 643, 661, 662, and 663, and left eye light sources 651, 652, 653, 671, 672, and 673.

Here, the second cameras 675a and 675b may correspond to the camera portion 451 of FIG. 4, and the right eye light sources 641, 642, 643, 661, 662, and 663 and the left eye light sources 651, 652, 653, 671, 672, and 673 may correspond to the plurality of light sources 452 and 453 of FIG. 4.

In an embodiment of the disclosure, a display (e.g., the first display 605 and the second display 610) may include, for example, a liquid crystal display (LCD), a digital micromirror device (DMD), or a liquid crystal on silicon (LCoS), an organic light-emitting diode (OLED), or a micro-LED. Although not shown in the drawings, when the display is one of an LCD, a DMD, and an LCoS, the electronic device 600 may include a light source that emits light to a screen output area of the display. In another embodiment of the disclosure, when the display is capable of generating light by itself, when the display is either an OLED or a micro-LED, for example, the electronic device 600 may provide a virtual image with a relatively high quality to the user even though a separate light source is not included. In an embodiment of the disclosure, when the display is implemented as an OLED or a micro-LED, a light source may be unnecessary, which may lead to weight reduction of the electronic device 600. Hereinafter, a display capable of generating light by itself may be referred to as a “self-luminous display,” and the description is made on the assumption of the self-luminous display.

The display (e.g., the first display 605 and the second display 610) according to various embodiments of the disclosure may include at least one micro-LED. For example, the micro-LED may express red (R), green (G), and blue (B) by emitting light by itself, and a single chip may implement a single pixel (e.g., one of R, G, and B pixels) because the micro-LED is relatively small in size (e.g., 100 micrometers (μm) or less). Accordingly, it may be possible to provide high resolution without a backlight unit (BLU) when the display is implemented as a micro-LED.

However, embodiments are not limited thereto. A pixel may include R, G, and B pixels, and a single chip may be implemented by a plurality of pixels including R, G, and B pixels.

In an embodiment of the disclosure, the display (e.g., the first display 605 and the second display 610) may include a display area including pixels for displaying a virtual image, and light-receiving pixels (e.g., photo sensor pixels) that are arranged among the pixels and configured to receive light reflected from the eyes, convert the received light into electrical energy, and output the electrical energy.

In an embodiment of the disclosure, the electronic device 600 may detect an eye gaze (e.g., a movement of a pupil) of the user through the light-receiving pixels. For example, the electronic device 600 may detect and track an eye gaze of the right eye of the user and an eye gaze of the left eye of the user through one or more light-receiving pixels of the first display 605 and one or more light-receiving pixels of the second display 610. The electronic device 600 may determine a central position of a virtual image according to the eye gazes (e.g., directions in which the pupils of the right eye and the left eye of the user gaze) of the right eye and the left eye of the user, which are detected through the one or more light-receiving pixels.

In an embodiment of the disclosure, the odd-numbered right eye light sources 641, 642, and 643, the right eye light sources 641, 642, 643, 661, 662, and 663, and the left eye light sources 651, 652, 653, 671, 672, and 673, which are attached around the frame of the electronic device 600 may be used as auxiliary means to facilitate detection of eye gaze when capturing the pupil with the second cameras 675a and 675b. When the right eye light sources 641, 642, 643, 661, 662, and 663 and the left eye light sources 651, 652, 653, 671, 672, and 673 are used as auxiliary means for detecting the eye gaze, the right eye light sources 641, 642, 643, 661, 662, and 663 and the left eye light sources 651, 652, 653, 671, 672, and 673 may include LEDs or IR LEDs that generate infrared wavelengths.

In an embodiment of the disclosure, light emitted from the display (e.g., the first display 605 and the second display 610) may reach the first screen display portion 615a formed in the first transparent member 625a that faces the right eye of the user and the second screen display portion 615b formed in the second transparent member 625b that faces the left eye of the user, by passing through a lens (not shown) and a waveguide. For example, the light emitted from the display (e.g., the first display 605 and the second display 610) may pass through the waveguide and may be reflected by a grating area formed in the input optical member 620, the first screen display portion 615a, and the second screen display portion 615b, to be transmitted to the eyes of the user. The first transparent member 625a and/or the second transparent member 625b may be formed as a glass plate, a plastic plate, or a polymer, and may be transparently or translucently formed.

In an embodiment of the disclosure, a lens (not shown) may be disposed on the front surface of the display (e.g., the first display 605 and the second display 610). The lens (not shown) may include a concave lens and/or a convex lens. For example, the lens (not shown) may include a projection lens or a collimation lens.

In an embodiment of the disclosure, the first screen display portion 615a and the second screen display portion 615b or a transparent member (e.g., the first transparent member 625a and the second transparent member 625b) may include a lens including a waveguide and a reflective lens.

In an embodiment of the disclosure, the waveguide may be formed of glass, plastic, or polymer and may have a nanopattern formed on one surface of the inside or outside, for example, a grating structure of a polygonal or curved shape. According to an embodiment of the disclosure, light incident to one end of the waveguide may be propagated inside the display waveguide through the nanopattern to be provided to the user. In an embodiment of the disclosure, a waveguide including a freeform prism may provide incident light to the user through a reflection mirror. The waveguide may include at least one of at least one diffractive element (e.g., a diffractive optical element (DOE) and a holographic optical element (HOE)) or a reflective element (e.g., a reflection mirror). In an embodiment of the disclosure, the waveguide may guide light emitted from the first display 605 and the second display 610 to the eyes of the user, using the at least one diffractive element or the reflective element included in the waveguide.

According to various embodiments of the disclosure, the diffractive element may include the input optical member 620 and/or an output optical member (not shown). For example, the input optical member 620 may be an input grating area, and the output optical member (not shown) may be an output grating area. The input grating area may function as an input terminal to diffract (or reflect) light output from the display (e.g., the first display 605 and the second display 610 (e.g., a micro-LED)) to transmit the light to transparent members (e.g., a first transparent member 650a and a second transparent member 650b) of the first screen display portion 615a and the second screen display portion 615b. The output grating area may function as an exit to diffract (or reflect), to the eyes of the user, the light transmitted to the transparent members (e.g., the first transparent member 650a and the second transparent member 650b) of the waveguide.

According to various embodiments of the disclosure, the reflective element may include a total reflection optical element or a total reflection waveguide for total internal reflection (TIR). For example, TIR, which is a scheme of inducing light, may be forming an angle of incidence to allow light (e.g., a virtual image) input through the input grating area to be completely (100%) reflected from one surface (e.g., a specific surface) of the waveguide such that the light may be completely (100%) transmitted to the output grating area.

In an embodiment of the disclosure, the light emitted from the first display 605 and the second display 610 may be guided by the waveguide through the input optical member 620. Light traveling in the waveguide may be guided toward the eyes of the user through the output optical member. The first screen display portion 615a and the second screen display portion 615b may be determined based on light emitted toward the eyes.

In an embodiment of the disclosure, the first cameras 645a, 645b, 645c, and 645d may each include a camera used for six degrees of freedom (6DoF), 6DoF head tracking, hand detection and tracking, and gesture and/or space recognition. For example, the first cameras 645a, 645b, 645c, and 645d may each include a global shutter (GS) camera to detect a movement of the head and a hand and track the movement.

For example, a stereo camera may be applied to the first cameras 645a, 645b, 645c, and 645d for head tracking and space recognition, and a camera with the same standard and performance may be applied. A GS camera having excellent performance (e.g., image dragging) may be used as the first cameras 645a, 645b, 645c, and 645d to detect a minute movement, such as a quick movement of a hand or a finger, and to track a movement.

According to various embodiments of the disclosure, a rolling shutter (RS) camera may be used as the first cameras 645a, 645b, 645c, and 645d. The first cameras 645a, 645b, 645c, and 645d may perform a function of simultaneous localization and mapping (SLAM) through depth imaging and space recognition for 6DoF. The first cameras 645a, 645b, 645c, and 645d may perform a user gesture recognition function.

In an embodiment of the disclosure, the second cameras 675a and 675b may be used for detecting and tracking the pupil. The second cameras 675a and 675b may also be referred to as cameras for eye tracking (ET). The second cameras 675a and 675b may track the eye gaze of the user. Considering the eye gaze of the user, the electronic device 600 may position the center of a virtual image projected on the first screen display portion 615a and the second screen display portion 615b according to the gaze direction of the user.

A GS camera may be used as the second cameras 675a and 675b to detect the pupil and track a quick movement of the pupil. The second cameras 675a and 675b may be installed respectively for the right eye and the left eye, and cameras having the same performance and standard may be used as the second cameras 675a and 675b for the right eye and the left eye.

In an embodiment of the disclosure, the third camera 665 may also be referred to as a “high resolution (HR)” or a “photo video (PV)” and may include a high-resolution camera. The third camera 665 may include a color camera having functions for obtaining a high-quality image, such as an automatic focus (AF) function and an optical image stabilizer (OIS). Embodiments are not limited thereto, and the third camera 665 may include a GS camera or an RS camera.

In an embodiment of the disclosure, at least one sensor (e.g., a gyro sensor, an acceleration sensor, a geomagnetic sensor, a touch sensor, an illuminance sensor, and/or a gesture sensor) and the first cameras 645a, 645b, 645c, and 645d may perform at least one of head tracking for 6DoF, pose estimation and prediction, gesture and/or space recognition, or a function of SLAM through depth imaging.

In another embodiment of the disclosure, the first cameras 645a, 645b, 645c, and 645d may be classified and used as a camera for head tracking and a camera for hand tracking.

In an embodiment of the disclosure, the lighting portions 630a and 630b may be used differently according to positions to which the lighting portions 630a and 630b are attached. For example, the lighting portions 630a and 630b may be attached together with the first cameras 645a, 645b, 645c, and 645d mounted around a hinge (e.g., the first hinge 640a and the second hinge 640b) that connects a frame and a temple or around a bridge that connects frames. If capturing is performed using a GS camera, the lighting portions 630a and 630b may be used to supplement the surrounding brightness. For example, the lighting portions 630a and 630b may be used in a dark environment or when it is not easy to detect a subject to be captured due to reflected light and mixing of various light sources.

In an embodiment of the disclosure, a PCB (e.g., the first PCB 635a and the second PCB 635b) may include a processor (not shown), memory (not shown), and a communication module (not shown) that control components of the electronic device 600.

The communication module (not shown) may support establishing a direct (e.g., wired) communication channel or wireless communication channel between the electronic device 600 and an external electronic device and performing communication through the established communication channel. The PCB may transmit electrical signals to the components constituting the electronic device 600.

The communication module (not shown) may include one or more communication processors that are operable independently of the processor and that support a direct (e.g., wired) communication or a wireless communication. According to an embodiment of the disclosure, the communication module (not shown) may include a wireless communication module (e.g., a cellular communication module, a short-range wireless communication module, or a GNSS communication module) or a wired communication module (e.g., a LAN communication module, or a PLC module). A corresponding one (not shown) of these communication modules may communicate with the external electronic device via a short-range communication network (e.g., Bluetooth™, Wi-Fi direct, or IrDA) or a long-range communication network (e.g., a legacy cellular network, a 5G network, a next-generation communication network, the Internet, or a computer network (e.g., a LAN or a WAN). These various types of communication modules may be implemented as a single component (e.g., a single chip), or may be implemented as multiple components (e.g., multiple chips) separate from each other.

The wireless communication module may support a 5G network after a 4G network, and a next-generation communication technology, e.g., an NR access technology. The NR access technology may support eMBB, mMTC, or URLLC. The wireless communication module may support a high-frequency band (e.g., a mmWave band) to achieve, e.g., a high data transmission rate. The wireless communication module may support various technologies for securing performance on a high-frequency band, such as, e.g., beamforming, massive MIMO, FD-MIMO, an array antenna, analog beamforming, or a large scale antenna.

The electronic device 600 may further include an antenna module (not shown). The antenna module may transmit or receive a signal or power to or from the outside (e.g., the external electronic device). According to an embodiment of the disclosure, the antenna module may include an antenna including a radiating element including a conductive material or a conductive pattern formed in or on a substrate (e.g., the first PCB 635a and the second PCB 635b). According to an embodiment of the disclosure, the antenna module may include a plurality of antennas (e.g., array antennas).

In an embodiment of the disclosure, a plurality of microphones (e.g., the first microphone 650a, the second microphone 650b, and the third microphone 650c) may process an external sound signal as electrical sound data. The processed sound data may be variously utilized according to a function (or an application being executed) being performed by the electronic device 600.

In an embodiment of the disclosure, the plurality of speakers (e.g., the first speaker 655a and the second speaker 655b) may output audio data received from the communication module or stored in the memory.

In an embodiment of the disclosure, one or more batteries 660 may be included, and may supply power to components constituting the electronic device 600.

In an embodiment of the disclosure, the visors 670a and 670b may adjust a transmittance amount of external light incident on the user's eyes according to the transmittance. The visors 670a and 670b may be disposed in front of or behind the first screen display portion 615a and the second screen display portion 615b. The front side of the first screen display portion 615a and the second screen display portion 615b may refer to a direction opposite to the user wearing the electronic device 600, and the rear side may refer to a direction of the user wearing the electronic device 600. The visors 670a and 670b may protect the first screen display portion 615a and the second screen display portion 615b and adjust an amount of external light transmitted.

For example, the visors 670a and 670b may include an electrochromic element that changes color according to applied power to adjust the transmittance. Electrochromism is a phenomenon in which colors change due to an oxidation-reduction reaction caused by applied power. The visors 670a and 670b may adjust the transmittance of external light, using the change in colors in the electrochromic element.

For example, the visors 670a and 670b may include a control module and the electrochromic element. The control module may control the electrochromic element to adjust the transmittance of the electrochromic element.

According to an embodiment of the disclosure, a method of controlling a light source for eye tracking, the method may include performing user calibration using eye tracking technology, by analyzing eye data of a user, which is acquired through the user calibration, and calculating an activity of each of light sources according to a gaze of the user, generating an activation map of each of the light sources, verifying a first eye gaze that is an eye gaze of the user, which is verified through an image obtained by capturing a pupil of the user, verifying control information of each of the light sources corresponding to the first eye gaze in the activation map of each of the light sources, and controlling each of the light sources according to the control information.

According to an embodiment of the disclosure, the activation map may include control information of each of the light sources according to an eye gaze of the user.

According to an embodiment of the disclosure, the activation map may be expressed as a 3D matrix, in which a first axis of the 3D matrix may represent an X-axis gaze direction of the user, a second axis may represent a Y-axis gaze direction of the user, a third axis may represent identification information that identifies a light source, and a cell value of the 3D matrix may be control information of a light source corresponding to identification information under a corresponding condition.

According to an embodiment of the disclosure, the verifying of the control information of each of the light sources may include verifying the control information of each of the light sources in the activation map by considering the first eye gaze and a previous eye gaze of the user.

According to an embodiment of the disclosure, the control information of each of the light sources may be information to turn each of the light sources on or off.

According to an embodiment of the disclosure, the control information of each of the light sources may be information to turn each of the light sources on or off, each of which is indicated by 0 or 1.

According to an embodiment of the disclosure, the control information of each of the light sources may be information indicating brightness of each of the light sources.

According to an embodiment of the disclosure, the control information of each of the light sources may be information indicating a brightness value of each of the light sources, each of which is indicated as a real value between 0 and 1.

According to an embodiment of the disclosure, the verifying of the control information of each of the light sources may include setting the control information of each of the light sources to turn each of the light sources on at preset brightness when the first eye gaze is not detected.

According to an embodiment of the disclosure, the preset brightness may be brightness required to capture the pupil of the user using a camera to detect a gaze direction of the user.

According to an embodiment of the disclosure, the method for controlling the light source for eye tracking may further include verifying a second eye gaze, which is an eye gaze of the user, using a glint generated in eyes of the user by each of the controlled light sources according to the control information and determining a final eye gaze of the user by considering the first eye gaze and the second eye gaze.

According to an embodiment of the disclosure, an apparatus for controlling a light source for eye tracking, the apparatus may include a camera configured to capture eyes of a user, light sources configured to acquire eye information of the user, a calibration processing portion configured to perform user calibration using eye tracking technology, an activation map generation portion configured to generate, by analyzing eye data of the user, which is acquired through the user calibration, and calculating an activity of each of the light sources according to a gaze of the user, an activation map of each the light sources, a first eye tracking portion configured to verify a first eye gaze, which is an eye gaze of the user, through an eye image of the user, which is captured by the camera, a control information verification portion configured to verify control information of each of the light sources corresponding to the first eye gaze in the activation map of each of the light sources, and a light control portion configured to control each of the light sources according to the control information.

According to an embodiment of the disclosure, the activation map may include control information of each of the light sources according to an eye gaze of the user.

According to an embodiment of the disclosure, the activation map may be expressed as a 3D matrix, in which a first axis of the 3D matrix may represent an X-axis gaze direction of the user, a second axis may represent a Y-axis gaze direction of the user, a third axis may represent identification information that identifies a light source, and a cell value of the 3D matrix may be control information of a light source corresponding to identification information under a corresponding condition.

According to an embodiment of the disclosure, the control information verification portion may be configured to verify the control information of each of the light sources in the activation map by considering a current eye gaze of the user and a previous eye gaze of the user.

According to an embodiment of the disclosure, the control information of each of the light sources may be information to turn each of the light sources on or off or information indicating brightness of each of the light sources.

According to an embodiment of the disclosure, the control information verification portion may be configured to set the control information to turn each of the light sources on at preset brightness when a current eye gaze of the user is not detected.

According to an embodiment of the disclosure, the preset brightness may be brightness required to capture the pupil of the user using the camera to detect the gaze direction of the user.

According to an embodiment of the disclosure, the apparatus for controlling the light source for eye tracking may further include a second eye tracking portion configured to verify a second eye gaze, which is an eye gaze of the user, using a glint generated in the eyes of the user by each of the controlled light sources according to the control information and a gaze determination portion configured to determine the final eye gaze of the user by considering the first eye gaze and the second eye gaze.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments of the disclosure, or they may be of the kind well-known and available to those having skill in the computer software arts. Examples of non-transitory computer-readable media include magnetic media, such as hard disks, floppy disks, and magnetic tape, optical media, such as compact disc read-only memory (CD-ROM) discs or digital versatile discs (DVDs), magneto-optical media, such as optical discs, and hardware devices that are specially configured to store and perform program instructions, such as read-only memory (ROM), random-access memory (RAM), flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described embodiments of the disclosure, or vice versa.

The software may include a computer program, a piece of code, an instruction, or some combinations thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording mediums.

Suitable results may be achieved if the described techniques are performed in a different order, and/or if components in a described system, architecture, device, or circuit are combined in a different manner, and/or rearranged or supplemented by other components or their equivalents.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of controlling a light source for eye tracking, the method comprising:
performing user calibration using eye tracking technology;
by analyzing eye data of a user, which is acquired through the user calibration, and calculating an activity of each of light sources according to a gaze of the user, generating an activation map of each of the light sources;
verifying a first eye gaze that is an eye gaze of the user, which is verified through an image obtained by capturing a pupil of the user;
verifying control information of each of the light sources corresponding to the first eye gaze in the activation map of each of the light sources; and
controlling each of the light sources according to the control information.

2. The method of claim 1, wherein the activation map comprises control information of each of the light sources according to an eye gaze of the user.

3. The method of claim 1,
wherein the activation map is expressed as a three-dimensional (3D) matrix, and
wherein a first axis of the 3D matrix represents an X-axis gaze direction of the user, a second axis represents a Y-axis gaze direction of the user, a third axis represents identification information that identifies a light source, and a cell value of the 3D matrix is control information of a light source corresponding to identification information under a corresponding condition.

4. The method of claim 1, wherein the verifying of the control information of each of the light sources comprises verifying the control information of each of the light sources in the activation map by considering the first eye gaze and a previous eye gaze of the user.

5. The method of claim 1, wherein the control information of each of the light sources is information to turn each of the light sources on or off.

6. The method of claim 1, wherein the control information of each of the light sources is information to turn each of the light sources on or off, each of which is indicated by 0 or 1.

7. The method of claim 1, wherein the control information of each of the light sources is information indicating brightness of each of the light sources.

8. The method of claim 1, wherein the control information of each of the light sources is information indicating a brightness value of each of the light sources, each of which is indicated as a real value between 0 and 1.

9. The method of claim 1, wherein the verifying of the control information of each of the light sources comprises setting the control information of each of the light sources to turn each of the light sources on at preset brightness when the first eye gaze is not detected.

10. The method of claim 9, wherein the preset brightness is brightness required to capture the pupil of the user using a camera to detect a gaze direction of the user.

11. The method of claim 1, further comprising:
verifying a second eye gaze, which is an eye gaze of the user, using a glint generated in eyes of the user by each of the controlled light sources according to the control information; and
determining a final eye gaze of the user by considering the first eye gaze and the second eye gaze.

12. An apparatus for controlling a light source for eye tracking, the apparatus comprising:
a camera configured to capture eyes of a user;
light sources configured to acquire eye information of the user;
a calibration processing portion configured to perform user calibration using eye tracking technology;
an activation map generation portion configured to generate, by analyzing eye data of the user, which is acquired through the user calibration, and calculating an activity of each of the light sources according to a gaze of the user, an activation map of each the light sources;
a first eye tracking portion configured to verify a first eye gaze, which is an eye gaze of the user, through an eye image of the user, which is captured by the camera;
a control information verification portion configured to verify control information of each of the light sources corresponding to the first eye gaze in the activation map of each of the light sources; and
a light control portion configured to control each of the light sources according to the control information.

13. The apparatus of claim 12, wherein the activation map comprises control information of each of the light sources according to an eye gaze of the user.

14. The apparatus of claim 12,
wherein the activation map is expressed as a three-dimensional (3D) matrix, and
wherein a first axis of the 3D matrix represents an X-axis gaze direction of the user, a second axis represents a Y-axis gaze direction of the user, a third axis represents identification information that identifies a light source, and a cell value of the 3D matrix is control information of a light source corresponding to identification information under a corresponding condition.

15. The apparatus of claim 12, wherein the control information verification portion is configured to verify the control information of each of the light sources in the activation map by considering a current eye gaze of the user and a previous eye gaze of the user.

16. The apparatus of claim 12, wherein the control information of each of the light sources is information to turn each of the light sources on or off.

17. The apparatus of claim 12, wherein the control information of each of the light sources is information to turn each of the light sources on or off, each of which is indicated by 0 or 1.

18. The apparatus of claim 12, wherein the control information of each of the light sources is information indicating brightness of each of the light sources.

19. One or more non-transitory computer-readable storage media storing one or more computer programs including computer-executable instruction that, when executed by one or more processors of an apparatus individually or collectively, cause the apparatus to perform operations of controlling a light source for eye tracking, the operations comprising:
performing user calibration using eye tracking technology;
by analyzing eye data of a user, which is acquired through the user calibration, and calculating an activity of each of light sources according to a gaze of the user, generating an activation map of each of the light sources;
verifying a first eye gaze that is an eye gaze of the user, which is verified through an image obtained by capturing a pupil of the user;
verifying control information of each of the light sources corresponding to the first eye gaze in the activation map of each of the light sources; and
controlling each of the light sources according to the control information.

20. The one or more non-transitory computer-readable storage media of claim 19, wherein the activation map comprises control information of each of the light sources according to an eye gaze of the user.
